(19) United States
(12) Patent Application Publication
(10) Pub. No.: US 2024/0357491 A1
(43) Pub. Date: Oct. 24, 2024

(54) SYSTEMS, METHODS, AND DEVICES FOR LOW-POWER OPERATION OF WIRELESS DEVICES

(71) Applicant: Cypress Semiconductor Corporation, San Jose, CA (US)

(72) Inventors: Victor ZHODZISHSKY, Potomac, MD (US); Manamohan MYSORE, Ramona, CA (US); Balasubramanyam RANGINENI, San Diego, CA (US)

(73) Assignee: Cypress Semiconductor Corporation, San Jose, CA (US)

(21) Appl. No.: 18/476,744

(22) Filed: Sep. 28, 2023

Related U.S. Application Data
(60) Provisional application No. 63/497,942, filed on Apr. 24, 2023.

(51) Int. Cl. H04W 52/02

(52) U.S. Cl. CPC H04W 52/0222; H04W 52/0225

(57) ABSTRACT

Systems, methods, and devices provide low-power-low-latency communication between wireless devices. Methods include determining, using a processing device, state information identifying a state of a first wireless device, and determining, using the processing device, that a data packet should be sent to a second wireless device based on an identified change in the state information. Methods may further include generating, using the processing device, a data packet for transmission from the first wireless device to the second wireless device via an isochronous wireless channel, wherein the data packet is configured to include the state information identifying the change.

### TECHNICAL FIELD

This disclosure relates to wireless devices, and more specifically, to enhancement of power consumption efficiency of such wireless devices.

### BACKGROUND

Wireless devices may communicate with each other via one or more wireless modalities, such as a Wi-Fi connection or a Bluetooth connection. Accordingly, such wireless communication may be implemented in a manner compliant with a wireless protocol. Moreover, such wireless devices may include various hardware components to facilitate such communication. For example, wireless devices may include one or more transceivers compatible with such wireless protocols. However, conventional techniques for providing connectivity between wireless devices remain limited because they are not able to efficiently provide connectivity between central devices and peripheral devices in a manner that is power efficient, and also has a low latency.

### BRIEF DESCRIPTION OF THE DRAWINGS

FIG. 1 illustrates an example of a system for low-power operation of wireless devices, configured in accordance with some embodiments.

FIG. 2 illustrates an example of a device for low-power operation of wireless devices, configured in accordance with some embodiments.

FIG. 3 illustrates a flow chart of an example of a method for low-power operation of wireless devices, performed in accordance with some embodiments.

FIG. 4 illustrates a flow chart of another example of a method for low-power operation of wireless devices, performed in accordance with some embodiments.

FIG. 5 illustrates a flow chart of an example of an additional method for low-power operation of wireless devices, performed in accordance with some embodiments.

FIG. 6 illustrates a timing diagram of wireless communication operations, performed in accordance with some embodiments.

FIG. 7 illustrates another timing diagram of wireless communication operations, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may be implemented in a variety of contexts. For example, wireless devices may be implemented in a gaming context where a central gaming console is wirelessly connected to one or more gaming controllers. In such an example, the central console is configured as a central device, and the gaming controllers are configured as peripheral devices that operate similar to stations. In such an example, the wireless connections have stringent latency constraints as relatively large latencies can result in reduced performance of the gaming system. Conventional techniques for managing such wireless connections may use an asynchronous communication channel which may have a relatively high latency. Other conventional techniques may periodically send data packets, even when no new information is being transmitted, thus resulting in excessive data packet transmissions and inefficient medium and resource utilization. Accordingly, conventional techniques are not able to provide wireless communication in this context in a manner that is power efficient and low latency.

Various embodiments disclosed herein provide wireless communications between wireless devices in a manner that enables dynamic data packet transmission on an isochronous wireless channel. As disclosed herein, an isochronous wireless channel may be one in which wireless devices negotiate a regular schedule of data transmissions such that data is transmitted between them in accordance with regular and equal time intervals. In some embodiments, such an isochronous wireless channel may be defined, at least in part, by a wireless standard, such as a Bluetooth Low energy (BLE) standard. Usage of such isochronous transmissions may provide reduced latencies in data transmissions between participating wireless devices. As will be discussed in greater detail below, such an isochronous wireless channel may be configured to support dynamic determinations associated with the transmissions of data packets to reduce an overall number of data packet transmissions, and reduce an overall power consumption of a wireless device. Furthermore, such dynamic determinations may also enable the interleaving of power saving operations between data packet transmissions. In this way, embodiments disclosed herein provide low-latency data transmission that is also power efficient.

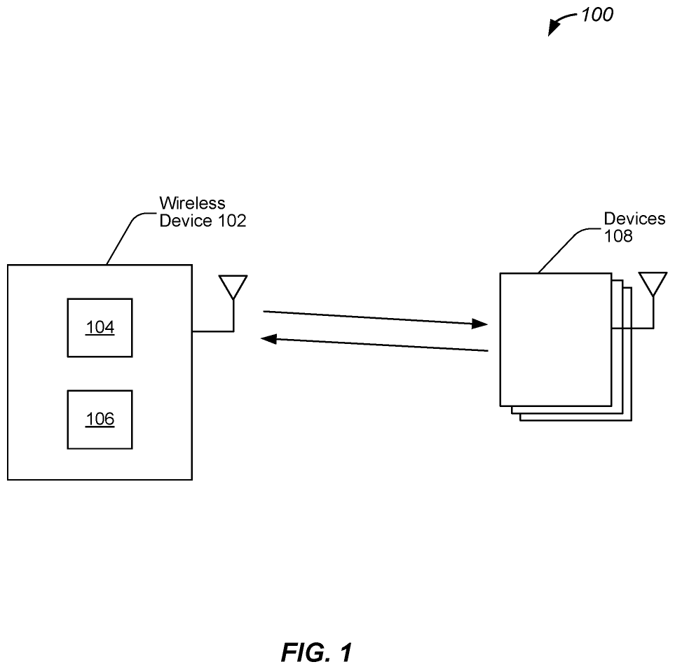

FIG. 1 illustrates an example of a system for low-power operation of wireless devices, configured in accordance with some embodiments. Accordingly, a system, such as system 100, may include wireless devices that are used for wireless communications, and are also configured to be able to perform operations to reduce power consumption, as disclosed herein. Accordingly, as will be discussed in greater detail below, wireless devices included in system 100 may be configured to dynamically determine if packets should be transmitted, and reduce a number of packet transmissions and associated power consumption based on such determinations.

In various embodiments, system 100 may include wireless device 102 which may be a wireless communications device. As discussed above, such wireless devices may be compatible with one or more wireless protocols, such as a Bluetooth protocol. In some embodiments, wireless device 102 includes a transceiver, such as transceiver 104. In one example, wireless device 102 may include transceiver 104 which is configured as a Bluetooth transceiver that has access to a communications medium and is configured to be compatible with a Blueotth specification and protocol. In some embodiments, the Bluetooth protocol may be a Bluetooth Low Energy (BLE) protocol. In various embodiments, wireless device 102 may be a central device in a system, such as a gaming system. For example, wireless device 102 may be a central console in a gaming system that includes additional peripheral devices configured as gaming controllers.

As shown in FIG. 1, various wireless communications devices may be in communication with each other via one or more wireless communications mediums. Moreover, wireless device 102 may each include one or more antennas, and may also include processing device 106. As disclosed herein a transceiver may also have associated transmit and receive chains and processing logic included in a corresponding radio. As will be discussed in greater detail below, such processing devices, transceivers, and radios may be configured to establish communications connections with other devices, and transmit data in the form of data packets via such communications connections and in accordance with a wireless protocol. Accordingly, wireless devices, such as wireless device 102, are configured to dynamically determine if packets should be transmitted, and reduce a number of packet transmissions and associated power consumption based on such determinations.

In some embodiments, system 100 may further include devices 108 which may also be wireless devices. As similarly discussed above, devices 108 may be compatible with one or more wireless transmission protocols, such as a Bluetooth protocol. In some embodiments, devices 108 may be configured as peripheral devices in communication with wireless device 102. For example, devices 108 may be gaming controllers in communication with a central gaming console. It will be appreciated that devices 108 may be any suitable type of device configured as a peripheral device in communication with central device. For example, devices 108 may be BLE devices or other devices, such as those found in cars, other vehicles, and medical implants. In various embodiments, devices 108 may be different types of devices than wireless device 102. As discussed above, each of devices 108 may include one or more antennas, as well as processing devices and transceivers, which may also be configured to establish communications connections with other devices, and transmit data in the form of data packets via such communications connections. As discussed above, devices 108 may also be configured to dynamically determine if packets should be transmitted, and reduce a number of packet transmissions and associated power consumption based on such determinations.

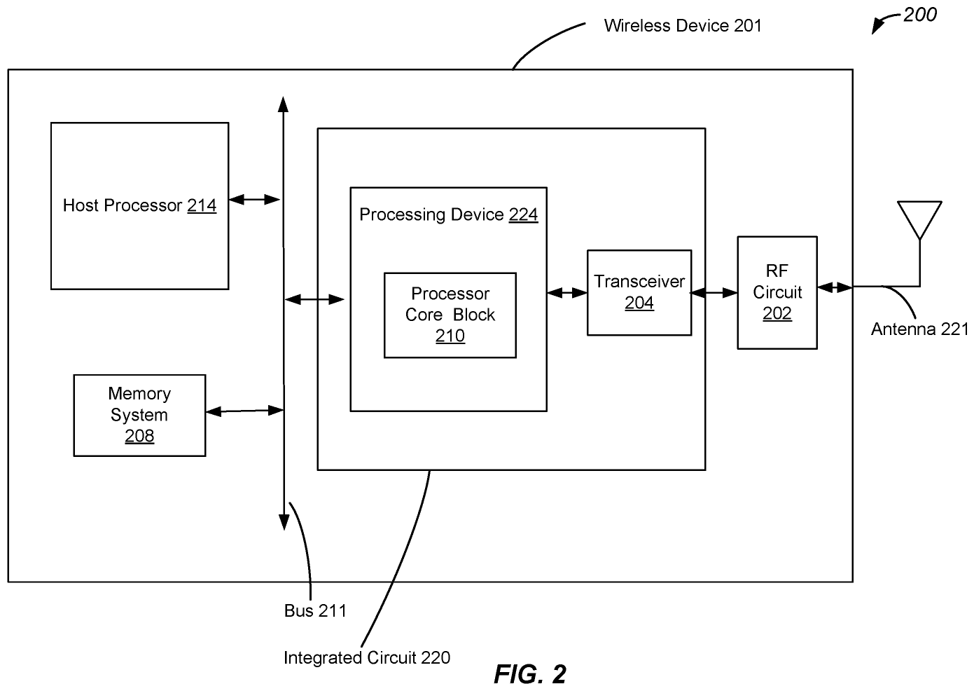

FIG. 2 illustrates an example of a device for low-power operation of wireless devices, configured in accordance with some embodiments. More specifically, FIG. 2 illustrates an example of a system, such as system 200, that includes wireless device 201. It will be appreciated that wireless device 201 may be one of any of the wireless devices discussed above with reference to FIG. 1, such as wireless device 102 and devices 108.

In various embodiments, wireless device 201 includes one or more transceivers, such as transceiver 204. In one example, system 200 includes transceiver 204 which is configured to transmit and receive signals using a communications medium that may include antenna 221. As noted above, transceiver 204 may be a Bluetooth transceiver. Accordingly, transceiver 204 may be compatible with a Bluetooth communications protocol. In one example, the Bluetooth protocol may be a Bluetooth Low Energy (BLE) protocol. In various embodiments, transceiver 204 includes a modulator and demodulator as well as one or more buffers and filters, that are configured to generate and receive signals via antenna 221. While various embodiments are described with reference to Bluetooth protocols, it will be appreciated that any suitable protocol may be used.

In various embodiments, system 200 further includes processing device 224 which may include logic implemented using processing elements and/or one or more processor cores. Accordingly, processing device 224 includes one or more processing devices comprising processing elements that are configured to dynamically determine if packets should be transmitted, and reduce a number of packet transmissions and associated power consumption based on such determinations. Moreover, processing device 224 includes one or more components configured to implement a medium access control (MAC) layer that is configured to control hardware associated with a wireless transmission medium. In one example, processing device 224 may include processor core block 210 that may be configured to implement a driver, such as a Bluetooth driver. In various embodiments, processing device 224 may be coupled to other components of wireless device 201 via a bus, such as bus 211.

In various embodiments, processor core block 210 comprises a processor core or multiple processor cores which are each configured to implement specific portions of a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers.

In various embodiments, one or more components of the Bluetooth stack implemented by processor core block 210 is configured to implement an acknowledgement scheme. For example, a link layer of a Bluetooth stack implemented in a central device is configured to implement an acknowledgement scheme, as will be discussed in greater detail below. For example, new state information may be received at a central device and may be delivered to the link layer. The link layer may send an acknowledgement message to a peripheral device, and may then send the new state information to an application layer of the Bluetooth stack that performs one or more communications operations with an application, such as a gaming application. For example, the application layer may pass the received information to the gaming application. In this way, an acknowledgement scheme implemented by the Bluetooth stack is configured to return an acknowledgement message to the peripheral device faster and with lower latency because the acknowledgement message is returned by the link layer, and does not depend on communications with the gaming application, as may occur with other implementations of acknowledgement schemes implemented by application layers where an acknowledgement message is sent after information has been successfully passed to a gaming application. Delivery of an acknowledgement message faster and with lower latency reduces a number of retransmissions implemented by the peripheral device, and reduces power consumption of the peripheral device.

System 200 further includes radio frequency (RF) circuit 202 which is coupled to antenna 221. In various embodiments, RF circuit 202 may include various components such as an RF switch, a diplexer, and a filter. While FIG. 2 illustrates system 200 as having two antennas, it will be appreciated that system 200 may have a single antenna, or any suitable number of antennas with any suitable number of RF circuits.

System 200 includes memory system 208 which is configured to store one or more data values associated with data packet transmission determinations discussed above and in greater detail below. Accordingly, memory system 208 includes storage device, which may be a non-volatile random access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204 and processing device 224 may be implemented on the same integrated circuit chip, such as integrated circuit chip 220. In another example, transceiver 204 and processing device 224 may each be implemented on their own chip, and thus may be disposed separately as a multi-chip module or on a common substrate such as a printed circuit board (PCB). It will also be appreciated that components of system 200 may be implemented in the context of a low energy device, a smart device, a gaming system, or a vehicle such as an automobile. Accordingly, some components, such as integrated chip 220, may be implemented in a first location, while other components, such as antenna 221, may be implemented in second location, and coupling between the two may be implemented via a coupler such as RF circuit 202.

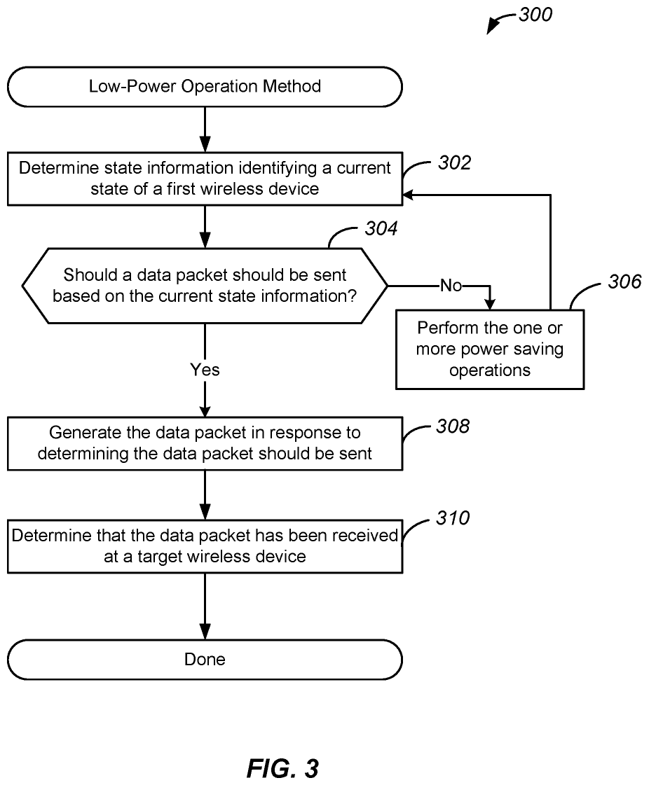

FIG. 3 illustrates a flow chart of an example of a method for low-power operation of wireless devices, performed in accordance with some embodiments. Accordingly, a method, such as method 300, may be performed to dynamically determine if packets should be transmitted, and reduce a number of packet transmissions and associated power consumption based on such determinations. More specifically, state information from a peripheral device, which may be configured as a peripheral component, such as a gaming controller, may dynamically determine if a current state of the peripheral device should trigger data packet transmission. Moreover, the devices may be configured to use an isochronous channel for such data packet transmission.

Method 300 may perform operation 302 during which state information identifying a current state of a first wireless device may be determined. In various embodiments, the state information may refer to a status of one or more components of a wireless device, or one or more components in communication with the wireless device. As will be discussed in greater detail below, the wireless device may be a peripheral device, such as a gaming controller communicating with a central console unit. Accordingly, the state information may identify one or more new events, such as a button press or other user action. In this way, the state information may identify an input received from a user and a corresponding change in a state of the peripheral device.

Method 300 may perform operation 304 during which it may be determined if a data packet should be sent based on the current state information. In various embodiments, such a determination may be made based on whether or not a change in the state information has been identified and/or if a previous state has not been acknowledged. If it is determined that no change has been detected, method 300 may perform operation 306 during which one or more power saving operations may be performed. Accordingly, the peripheral device may perform one or more designated operations such as determining that no data packet needs to be sent, and transitioning to a different operational mode. For example, the peripheral device may enter a power saving mode, and may periodically wake to return to operation 302.

Returning to operation 304, if it is determined that a change in the state information has been detected, method 300 may proceed to operation 308 during which a data packet may be generated. As will be discussed in greater detail below, the data packet may include the updated state information in a portion of the data packet. Moreover, it may be sent to a central device via an isochronous channel. Accordingly, the newly detected state information may be identified and packaged in a data packet that is sent to the central device to update the central device regarding the new state of the peripheral device.

Method 300 may perform operation 310 during which it may be determined that the data packet has been received at a target wireless device. Accordingly, during operation 310, the peripheral device may wait for an acknowledgment message from a central device and/or may obtain state information from the next available transmission from the central device. More specifically, the central device may acknowledge receipt of the data packet and send an acknowledgement message to the peripheral device via the isochronous channel. The acknowledgement message may include state information identifying a current state of the peripheral device as identified by the central device. Accordingly, the acknowledgement message may also include state information used to verify that the central device stores the current and correct state of the peripheral device. As will be discussed in greater detail below, if no acknowledgement message is received, the peripheral device may perform one or more operations such as data packet retransmission.

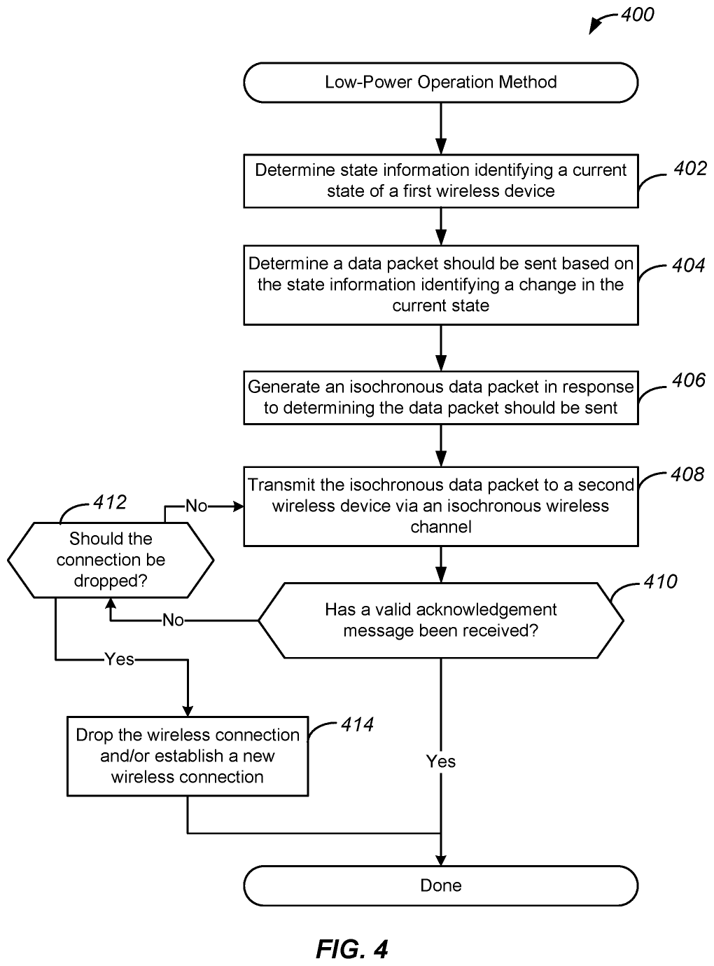

FIG. 4 illustrates a flow chart of another example of a method for low-power operation of wireless devices, performed in accordance with some embodiments. Accordingly, a method, such as method 400, may be performed to dynamically determine if packets should be transmitted, and reduce a number of packet transmissions and associated power consumption based on such determinations. As similarly discussed above, state information from a peripheral device, which may be configured as a peripheral component such as a gaming controller, may dynamically determine if a current state of the peripheral device should trigger data packet transmission. Moreover, the devices may be configured to use an isochronous channel for such data packet transmission, and may also be configured to perform one or more additional dynamic determinations regarding connection and channel usage.

Method 400 may perform operation 402 during which state information identifying a current state of a first wireless device may be determined. As similarly discussed above, the state information may refer to a status of one or more components of a wireless device, or one or more components in communication with the wireless device. For example, the state information may identify a state within a designated state machine known to both the peripheral device and the central device. The state information may identify an occurrence of an event, such as a user input received at an input device. Accordingly, the state information may be an event identifier.

As similarly discussed above, the wireless device may be a peripheral device, such as a gaming controller communicating with a central console unit. In the example of a gaming controller, the gaming controller may communicate state information frequently to accurately convey received inputs to a central console. Accordingly, as will be discussed in greater detail below, embodiments disclosed herein provide the ability to use an isochronous channel to convey such inputs with a relatively low latency.

Method 400 may perform operation 404 during which it may be determined that a data packet should be sent based on the state information identifying a change in the current state. As similarly discussed above, such a determination may be made based on whether or not a previous state change has been acknowledged, or a change in the state information has been identified. Accordingly, the peripheral device may monitor a current status as well as monitor one or more input devices. In the example of a gaming controller, the gaming controller may monitor a current state based on a designated state machine stored in logic of the gaming controller, as may be determined a manufacturer or software developer, or based on one or more event identifiers. Such a current state may be determined based, at least in part, on a status of input devices, such as buttons on the gaming controller. Accordingly, one or more button presses by a user may cause a change in a state of the controller, and thus be detected as a change in state information. In various embodiments, a change in state information may be determined based on a designated combination of input device statuses. Accordingly, one or more combinations of state changes may be used to determine if a data packet should be sent, and such combinations may be determined by an entity, such as a manufacturer or a software developer.

If it is determined that a change has been detected, method 400 may perform operation 406 during which an isochronous data packet may be generated in response to determining the data packet should be sent. As similarly discussed above, the data packet may include the updated state information in a portion of the data packet. Accordingly, the newly detected state information may be identified and packaged in a data payload of the data packet for transmission to the central device. In one example, the data packet may be a BLE data packet configured to use an isochronous channel of a BLE connection between the peripheral device and the central device. Accordingly, the BLE data packet may be augmented to include the state information in a portion of the data packet, such as a header. More specifically, both the central device and peripheral device may be configured to identify states based on one or more identifiers or a referencing scheme included in the data packet header. Such a referencing scheme may be determined by an entity, such as a manufacturer. The peripheral device may also determine scheduling information associated with the isochronous data packet and accordingly, may determine when the data packet should be transmitted.

Method 400 may perform operation 408 during which the isochronous data packet may be transmitted to a second wireless device via an isochronous wireless channel. As similarly discussed above, the data packet may be sent to a second wireless device, such as a central device, via an isochronous channel of a wireless connection. In one example, the data packet may be sent via an isochronous channel of a BLE connection between the peripheral device and the central device. Moreover, the data packet may be transmitted in accordance with the scheduling information discussed above. For example, the scheduling information may be configured such that a peripheral device sends data packets when a state has changed, and skips data packet transmissions when there has been no state change and a central device has acknowledged a current state, as will also be discussed in greater detail below.

Method 400 may perform operation 410 during which it may be determined if a valid acknowledgement message been received. In various embodiments, such a determination may be made based on a reply or non-reply of a central device. For example, during operation 410, the peripheral device may wait for an acknowledgment message from a central device and/or may obtain state information from the next available transmission from the central device. More specifically, the central device may acknowledge receipt of the data packet and send an acknowledgement message to the peripheral device via the isochronous channel. The acknowledgement message may include state information identifying a current state of the peripheral device as identified by the central device. The peripheral device may verify that the state information included in the reply message is correct, and determine that the acknowledgement message is valid. If the state information is not correct, or if no acknowledgement message is received within a designated period of time, it may be determined that no valid acknowledgment message was received. Accordingly, if it is determined that a valid acknowledgement message was received, method 400 may terminate, or may repeat for additional iterations of method 400. If it is determined that no valid acknowledgement message was received, method 400 may proceed to operation 412.

Accordingly, during operation 412 it may be determined if a currently used connection should be dropped. In various embodiments, if no valid acknowledgment message is received, it may be determined if it should be inferred that the wireless connection itself is bad, and should be dropped or terminated. Such a determination may be made based on one or more signal quality metrics, or one or more other connection parameters. For example, a data packet loss rate and/or a signal strength metrics, such as a received signal strength indication (RSSI) value, may be used to make such a determination by comparison of such values with a designated threshold value which may be set by an entity such as a manufacturer.

Thus, if it is determined that the currently used connection should not be dropped, method 400 may return to operation 408 where additional transmission operations may be performed. For example, the peripheral device may attempt retransmission of the data packet for a designated number of tries. If it is determined that the currently used connection should be dropped, method 400 may proceed to operation 414.

Method 400 may perform operation 414 during which the wireless connection may be dropped and/or a new wireless connection may be established. Accordingly, in response to determining that the wireless connection is bad, both the central device and peripheral device may establish a new connection. Moreover, the peripheral device may again attempt transmission of the data packet to ensure that it is received by the central device. In some embodiments, the central and peripheral devices may repeat this process until a valid acknowledgement message is received.

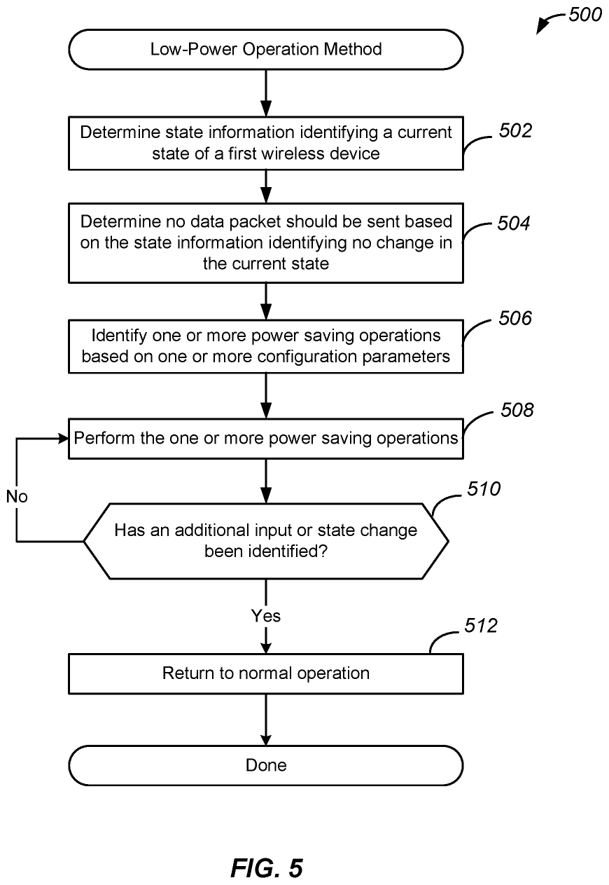

FIG. 5 illustrates a flow chart of an example of an additional method for low-power operation of wireless devices, performed in accordance with some embodiments. Accordingly, a method, such as method 500, may be performed to dynamically determine if packets should be transmitted, and reduce a number of packet transmissions and associated power consumption based on such determinations. As similarly discussed above, state information from a peripheral device may be used to dynamically determine if a current state of the peripheral device should trigger data packet transmission. As will be discussed in greater detail below, the peripheral device may dynamically determine whether or not data packet transmission should occur to reduce data packet transmissions that would otherwise occur on an isochronous channel, and thus reduce power consumption of the peripheral device.

Method 500 may perform operation 502 during which state information identifying a current state of a first wireless device may be determined. As similarly discussed above, the state information may refer to a status of one or more components of a wireless device, or one or more components in communication with the wireless device. For example, the state information may identify a state within a designated state machine known to both the peripheral device and the central device. The state information may identify an occurrence of an event, such as a user input received at an input device. Accordingly, the state information may be an event identifier.

Method 500 may perform operation 504 during which it may be determined that no data packet should be sent based on the state information identifying no change in the current state. As similarly discussed above, such a determination may be made based on whether or not a change in the state information has been identified. Accordingly, the peripheral device may monitor a current status as well as monitor one or more input devices. Such monitoring may include periodically polling the input devices and storing data values identifying the result of the polling. In one example, a gaming controller may monitor a current state based on a designated state machine stored in logic of the gaming controller, as may be determined a manufacturer or software developer, or based on one or more event identifiers. Accordingly, a change or no change may be detected based, for example, on a comparison of a current state with a previously stored state. In some embodiments, during operation 504 it is determined that no change in a current state has occurred based on a determination that the state information hasn't changed. In response to such a determination, the peripheral device may determine that additional transmission of a data packet is not needed, and that no data packet should be transmitted.

Method 500 may perform operation 506 during which one or more power saving operations may be identified based on one or more configuration parameters. According to some embodiments, an entity, such as a manufacturer, may have determined one or more power saving operations to be performed in response to determining that no transmission of a data packet is needed. For example, such power saving operations may include transitioning the peripheral device to a low-power mode. In some embodiments, the power saving operations may include setting just the wireless connection, or one or more associated components such as a transceiver, to a power saving mode. Accordingly, the configuration parameters may be stored in memory and may be retrieved during operation 506.

Method 500 may perform operation 508 during which the one or more power saving operations may be performed. Accordingly, one or more components of the peripheral device may be set to a power saving or low power mode. As discussed above, the isochronous channel may be set to a low power mode, or the entire peripheral device may be set to a low power mode for a designated period of time, as may be determined by the configuration parameters. In this way, in addition to avoiding power consumption costs associated with superfluous data packet transmissions, power consumption may be further reduced by dynamically applying power saving operations to the isochronous channel and associated components.

Method 500 may perform operation 510 during which it may be determined if an additional input or state change has been identified. In various embodiments, such a determination may be made based on a one or more dynamic inputs received at the peripheral device, or one or more periodic operations. For example, a user may provide an input by pressing a button, and such an input may cause the peripheral device to transition to an active mode, and identify the change in state information. In another example, the peripheral device may periodically transition to an active mode, perform one or more synchronization operations with a central device, and may return to a low power mode if no changes have been detected.

Thus, if it is determined that no additional input or state change has been identified, method 500 may return to operation 508 where the peripheral device may continue performing power saving operations. For example, the peripheral device may return to a low power mode for a designated period of time. If it is determined that an additional input or state change has been identified, method 500 may perform operation 512 during which the peripheral device may return to normal operation. Accordingly, the peripheral device may return to an active mode and may perform determination operations as well as data packet transmission operations as appropriate as described above with reference to FIG. 4.

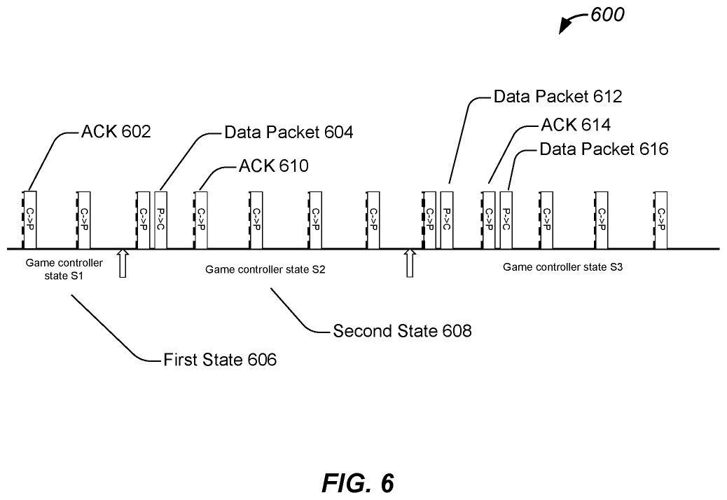

FIG. 6 illustrates a timing diagram of wireless communication operations, performed in accordance with some embodiments. Accordingly, image 600 illustrates a timing diagram of data packet transmissions on an isochronous channel, as well as corresponding state changes in a peripheral device. More specifically, a central device may periodically send acknowledgment messages, as shown by data packet ACK 602. Included in each acknowledgement message may be one or more data values identifying the most recent state of the peripheral device as known and stored by the central device. As shown in image 600, ACK 602 is sent from a central device to a peripheral device (C->P), and includes an acknowledgement message AckS1 that identifies a first state S1.

As also shown in image 600, events, such as button presses, may cause transitions between states of the peripheral device, such as a transition from first state 606 to second state 608. The change in state information may be detected by the peripheral device and may be used to determine that a data packet should be sent. Accordingly, data packet 604 may be sent from the peripheral device to the central device on the isochronous channel, and data packet 604 may include state information identifying the new state. As shown in image 600, data packet 604 is sent from the peripheral device to the central device (P->C), and identifies a new state S2. The updated state information may be identified in the next acknowledgement message, such as ACK 610. Accordingly, as shown in image 600, the peripheral device transmits isochronous data packets in response to dynamically detecting a state change, and does not transmit data packets on the isochronous channel otherwise. Image 600 additionally shows a retransmission operation. More specifically, data packet 612 is sent identifying a new state S3. However, ACK 614 still identifies the previous state S2. In response to receiving the previous state information, the peripheral device retransmits the new state information via data packet 616.

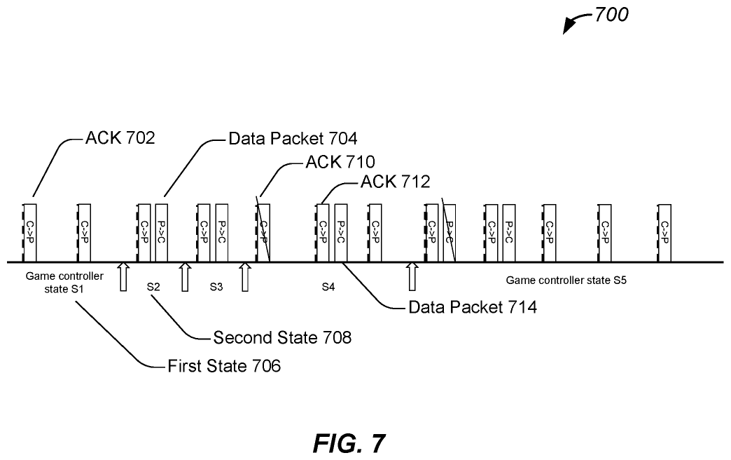

FIG. 7 illustrates another timing diagram of wireless communication operations, performed in accordance with some embodiments. As similarly discussed above, image 700 illustrates a timing diagram of data packet transmissions on an isochronous channel, as well as corresponding state changes in a peripheral device. A central device may periodically send acknowledgment messages, as shown by data packet ACK 702. As discussed above, included in each acknowledgement message may be one or more data values identifying the most recent state of the peripheral device as known and stored by the central device. As also shown in image 700, events, such as button presses, may cause transitions between states of the peripheral device, such as a transition from first state 706 to second state 708. The change in state information may be detected by the peripheral device and may be used to determine that a data packet should be sent. Accordingly, data packet 704 may be sent from the peripheral device to the central device on the isochronous channel, and data packet 704 may include state information identifying the new state.

As shown in image 700, there may be one or more data packets that are corrupted or not received. For example acknowledgement message 710 might not be received. Accordingly, subsequent acknowledgement message 712 might include state information of the last known state of peripheral device that is known to the central device, and in response, the most recent state information may be transmitted from the peripheral device via data packet 714.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
determining, using a processing device, state information identifying a state of a first wireless device;
determining, using the processing device, that a data packet should be sent to a second wireless device based on an identified change in the state information; and
generating, using the processing device, a data packet for transmission from the first wireless device to the second wireless device via an isochronous wireless channel, wherein the data packet is configured to include the state information identifying the change.

2. The method of claim 1, wherein the determining that the data packet should be sent further comprises:
identifying the change in the state information based on an input received from a user at the first wireless device.

3. The method of claim 1, wherein the data packet is a Bluetooth Low Energy (BLE) data packet, and wherein a header of the BLE data packet is configured to store the state information.

4. The method of claim 1 further comprising:
receiving an acknowledgement message from the second wireless device; and
determining that a data packet should not be sent based, at least in part, on the state information and the acknowledgement message.

5. The method of claim 4 further comprising:
performing one or more power saving operations in response to determining that a data packet should not be sent.

6. The method of claim 5, wherein the power saving operations further comprise:
setting the isochronous wireless channel to a low power mode.

7. The method of claim 5 further comprising:
determining the isochronous wireless channel should be terminated; and
switching to an additional isochronous wireless channel.

8. The method of claim 1, wherein the determining that a data packet should be sent is performed by a link layer of the first wireless device.

9. The method of claim 1, wherein the first wireless device is a gaming controller, and wherein the second wireless device is a gaming console.

10. A system comprising:
a transceiver configured to be compatible with a wireless protocol;
a processing device coupled to the transceiver and configured to:
determine state information identifying a state of a first wireless device;
determine that a data packet should be sent to a second wireless device based on an identified change in the state information; and
generate a data packet for transmission from the first wireless device to the second wireless device via an isochronous wireless channel, wherein the data packet is configured to include the state information identifying the change.

11. The system of claim 10, wherein the processing device is further configured to:
identify the change in the state information based on an input received from a user at the first wireless device.

12. The system of claim 10, wherein the determining that a data packet should be sent is performed by a link layer of the first wireless device, wherein the data packet is a Bluetooth Low Energy (BLE) data packet, and wherein a header of the BLE data packet is configured to store the state information.

13. The system of claim 10, wherein the processing device is further configured to:
receive an acknowledgement message from the second wireless device;
determine that a data packet should not be sent based, at least in part, on the state information and the acknowledgement message; and
perform one or more power saving operations in response to determining that a data packet should not be sent.

14. The system of claim 13, wherein the power saving operations further comprise:
setting the isochronous wireless channel to a low power mode.

15. The system of claim 13 further comprising:
determining the isochronous wireless channel should be terminated; and
switching to an additional isochronous wireless channel.

16. A device comprising:
processing elements configured to:
determine state information identifying a state of a first wireless device;
determine that a data packet should be sent to a second wireless device based on an identified change in the state information; and
generate a data packet for transmission from the first wireless device to the second wireless device via an isochronous wireless channel, wherein the data packet is configured to include the state information identifying the change.

17. The device of claim 16, wherein the processing elements are further configured to:
identify the change in the state information based on an input received from a user at the first wireless device.

18. The device of claim 16, wherein the determining that a data packet should be sent is performed by a link layer of the first wireless device, wherein the data packet is a Bluetooth Low Energy (BLE) data packet, and wherein a header of the BLE data packet is configured to store the state information.

19. The device of claim 16, wherein the processing elements are further configured to:
receive an acknowledgement message from the second wireless device;
determine that a data packet should not be sent based, at least in part, on the state information and the acknowledgement message; and
perform one or more power saving operations in response to determining that a data packet should not be sent.

20. The device of claim 19, wherein the power saving operations further comprise:
setting the isochronous wireless channel to a low power mode.
